(19) United States
(12) Patent Application Publication
(10) Pub. No.: US 2008/0258538 A1
(43) Pub. Date: Oct. 23, 2008

(54) PULL-TYPE BICYCLE HUB THAT CAN ELIMINATE A STRESS

(76) Inventor: Shu-Tzu Tsai Tu, Ta Ya Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/736,672

(22) Filed: Apr. 18, 2007

(51) Int. Cl. B60B 1/02

(52) U.S. Cl. 301/56

(57) ABSTRACT

A pull-type hub for a bicycle includes hub body, two bearings mounted in the hub body, and two bearing seats mounted in the hub body and each located between the hub body and a respective bearing. Thus, when each of the two opposite sides of the hub body is subjected to an outwardly pulled radial stress applied by the spokes, each of the bearing seats is located between the hub body and the respective bearing to eliminate the radial stress applied on each of the two opposite sides of the hub body by the spokes, so that each of the bearings is mounted in the hub body closely and will not be loosened from the hub body easily.

### BACKGROUND OF THE INVENTION

1. Field of the Invention

The present invention relates to a hub and, more particularly; to a pull-type hub for a bicycle.

2. Description of the Related Art

A conventional pull-type hub for a bicycle in accordance with the prior art shown in FIGS. 6 and 7 comprises a hub body 50, and two bearings 60 mounted in two opposite sides of the hub body 50 respectively. Each of the two opposite sides of the hub body 50 is formed with a plurality of through holes 52 for mounting a plurality of spokes 70. However, when each of the two opposite sides of the hub body 50 is subjected to an outwardly pulled radial stress applied by the spokes 70, the inner wall of each of the two opposite sides of the hub body 50 is expanded outwardly by outwardly pulled radial stress applied by the spokes 70 as indicated by the phantom lines shown in FIG. 7, so that each of the bearings 60 is loosened from the hub body 50 easily.

### BRIEF SUMMARY OF THE INVENTION

In accordance with the present invention, there is provided a hub, comprising a hub body, two bearings mounted in two opposite sides of the hub body respectively, and two bearing seats mounted in the two opposite sides of the hub body respectively and each located between the hub body and a respective bearing.

The primary objective of the present invention is to provide a putt-type bicycle hub that can eliminate a stress.

Another objective of the present invention is to provide a hub, wherein when each of the two opposite sides of the hub body is subjected to an outwardly pulled radial stress applied by the spokes, each of the bearing seats is located between the hub body and the respective bearing to eliminate the radial stress applied on each of the two opposite sides of the hub body by the spokes, so that each of the bearings is mounted in the hub body closely and will not be loosened from the hub body easily.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a hub in accordance with the preferred embodiment of the present invention.

FIG. 2 is a front cross-sectional assembly view of the hub as shown in FIG. 1.

FIG. 3 is a cross-sectional view of the hub taken along line 3-3 as shown in FIG. 2.

FIG. 4 is a partially front cross-sectional assembly view of a hub in accordance with another preferred embodiment of the present invention.

FIG. 5 is a partially front cross-sectional assembly view of a hub in accordance with another preferred embodiment of the present invention.

FIG. 6 is an exploded perspective view of a conventional hub in accordance with the prior art,

FIG. 7 is a partially front cross-sectional assembly view of the conventional hub as shown in FIG. 6.

### DETAILED DESCRIPTION OF THE INVENTION

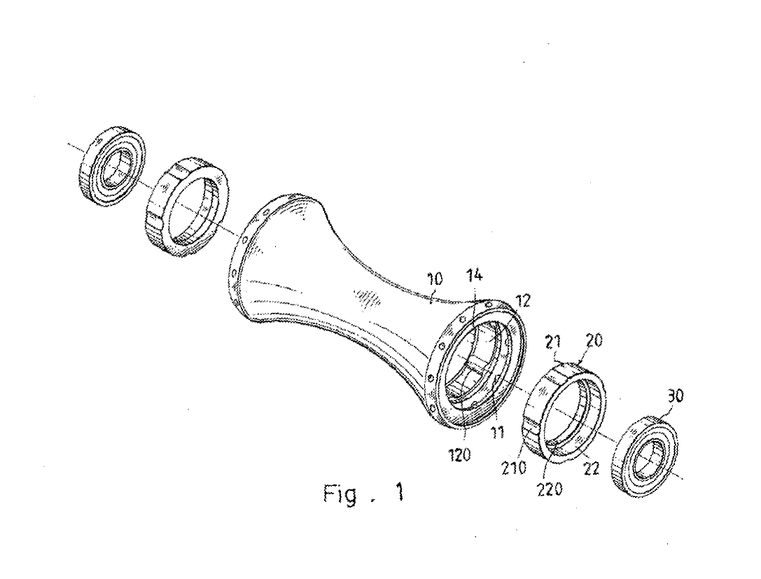

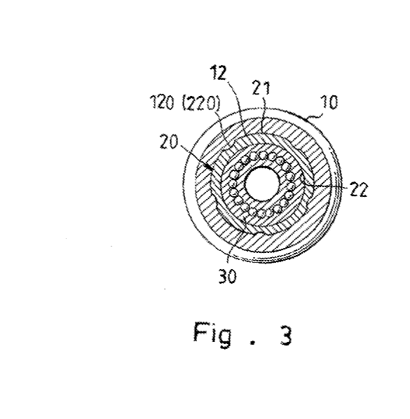

Referring to the drawings and initially to FIGS. 1-3, a pull-type hub for a bicycle in accordance with the preferred embodiment of the present invention comprises a hub body 10, two bearings 30 mounted in two opposite sides of the hub body 1 respectively, and two bearing seats 20 mounted in the two opposite sides of the hub body 10 respectively and each located between the hub body 10 and a respective bearing 30.

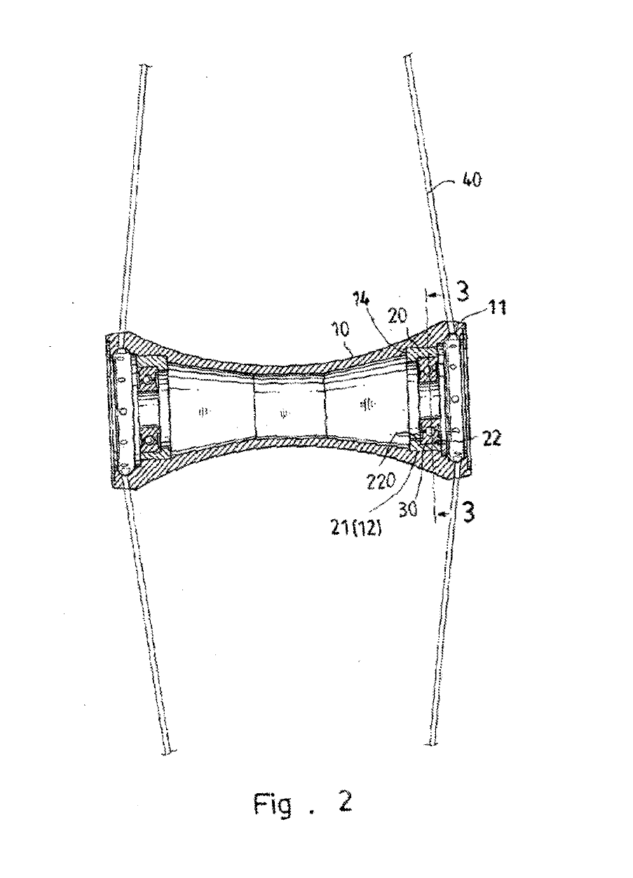

Each of the two opposite sides of the hub body 10 has a first portion formed with a plurality of through holes 11 for mounting a plurality of spokes 40 and a second portion formed with a radially and inwardly extending mounting portion 12 spaced from the through holes 11. The mounting portion 12 of the hub body 10 has a substantially annular shape and is formed with a plurality of radially and inwardly extending positioning ribs 120. Each of the positioning ribs 120 of the mounting portion 12 of the hub body 10 is substantially arc-shaped and extends in an axial direction of the hub body 10 Each of the two opposite sides of the hub body 10 has an inner edge formed with a stepped stop portion 14 located beside the mounting portion 12 to stop the respective bearing seat, 20 as show in FIG. 2.

Each of the bearing seats 20 has a substantially annular shape and is spaced from the through holes 11 of the hub body 10. Each of the bearing seats 20 is forcibly fitted into the mounting portion 12 of the hub body 10 and has an outer wall 21 rested on the mounting portion 12 of the hub body 10 and formed with a plurality of positioning grooves 210 locked on the positioning ribs 120 of the mounting portion 12 of the hub body 10 respectively to prevent each of the bearing seats 20 from being rotatable relative to the hub body 10. Each of the positioning grooves 210 of each of the bearing seats 20 is substantially arc-shaped and extends in an axial direction of each of the bearing seats 20. Thus, the positioning ribs 120 of the mounting portion 12 of the hub body 10 are slidably inserted into the positioning grooves 210 of each of the bearing seats 20 respectively when each of the bearing seats 20 is filed into the mounting portion 12 of the hub body 10. Each of the bearing seats 20 has an inner wall 22 rested on ant outer wall of the respective bearing 30 and formed with a stepped protruding catch portion 220 to stop the respective bearing 30.

Each of the bearings 30 is encompassed by and fully hidden in the respective bearing seat 20 as shown in FIG. 2.

Accordingly, when each of the two opposite sides of the hub body 10 is subjected to an outwardly pulled radial stress applied by the spokes 40, each of the bearing seats 20 is located between the hub body 10 and the respective bearing 30 to eliminate the radial stress applied on each of the two opposite sides of the hub body 10 by the spokes 40, so that each of the bearings 30 is mounted in the hub body 10 closely and will not be loosened from the hub body 10 easily.

Referring to FIG. 4 with reference to FIG. 1, the mounting portion 12 of the hub body 10 is formed with an inner threaded portion 121 which extends in an axial direction of the hub body 10, and each of the bearing seats 20 has an outer wall 21 formed with an outer threaded portion 211 screwed into the inner threaded portion 121 of the mounting portion 12 of the hub body 10. The outer 10 threaded portion 211 of each of the bearing seats 20 extends in an axial direction of each of the bearing seats 20.

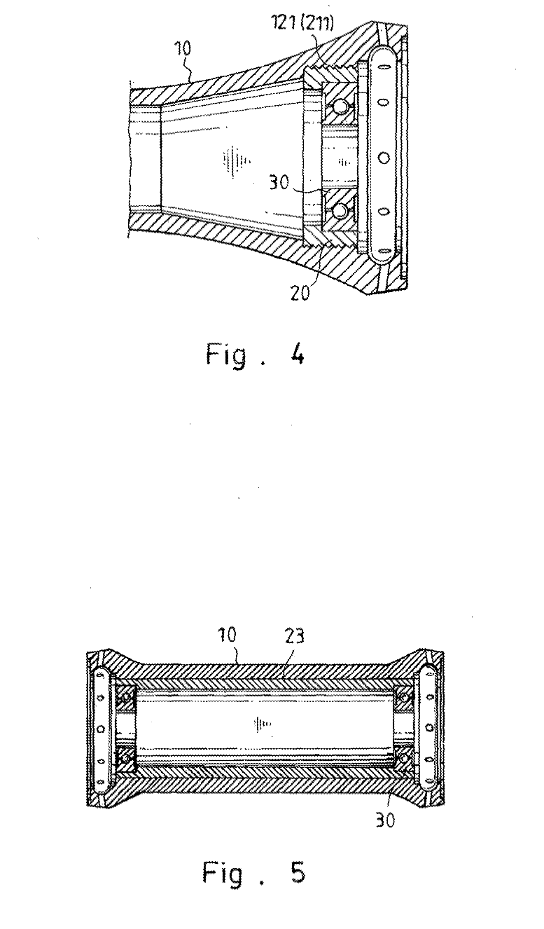

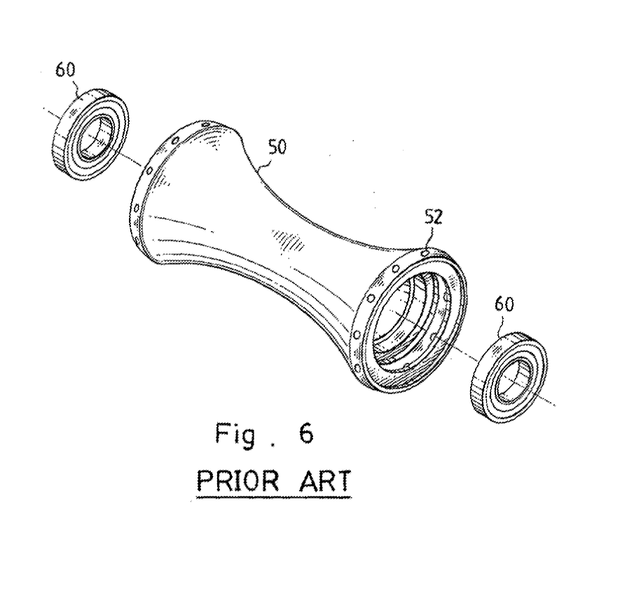

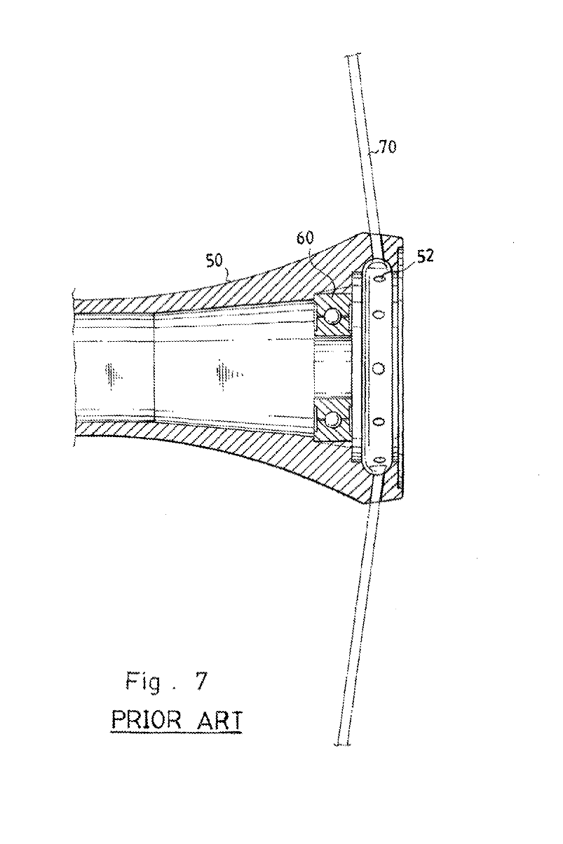

Referring to FIG. 5 with reference to FIG. 1, the bearing seats 20 are replaced by a sleeve 23 which is located between the hub body 10 and each of the bearings 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fail within the true scope of the invention.

1. A hub, comprising:
a hub body;
two bearings mounted in two opposite sides of the hub body respectively;
two bearing seats mounted in the two opposite sides of the hub body respectively and each located between the hub body and a respective bearing.

2. The hub in accordance with claim 1, wherein:
each of the two opposite sides of the hub body has a first portion formed with a plurality of through holes for mounting a plurality of spokes and a second portion formed with a radially and inwardly extending mounting portion spaced from the through holes;
each of the bearing seats is forcibly fitted into the mounting portion of the hub body and is spaced from the through holes of the hub body.

3. Tie hub in accordance with claim 2, wherein:
the mounting portion of the hub body is formed with a plurality of radially and inwardly extending positioning ribs;
each of the bearing seats has an outer wall rested on the mounting portion of the hub body and formed with a plurality of positioning grooves locked on the positioning ribs of the mounting portion of the hub body respectively to prevent each of the bearing seats from being rotatable relative to the hub body.

4. The hub in accordance with claim 1, wherein each of the bearing seats has an inner wall rested on an outer wall of the respective bearing and formed with a stepped protruding catch portion to stop the respective bearing.

5. The hub in accordance with claim 2, wherein:
the mounting portion of the hub body is formed with an inner threaded portion;
each of the bearing seats has an outer wall formed with an outer threaded portion screwed into the inner threaded portion of the mounting portion of the hub body.

6. The hub in accordance with claim 1, wherein the bearing seats are replaced by a sleeve which is located between the hub body and each of the bearings.

7. The hub in accordance with claim 5, wherein the inner threaded portion of the mounting portion of the hub body extends in an axial direction of the hub body.

8. The hub in accordance with claim 5, wherein the outer threaded portion of each of the bearing seats extends in an axial direction of each of the bearing seats.

9. The hub in accordance with claim 2, wherein the mounting portion of the hub body has a substantially annular shape.

10. The hub in accordance with claim 3, wherein each of the positioning ribs of the mounting portion of the hub body is substantially arc-shaped.

11. The hub in accordance with claim 3, wherein each of the positioning ribs of the mounting portion of the hub body extends in an axial direction of the hub body.

12. The hub in accordance with claim 2, wherein each of the two opposite sides of the hub body has an inner edge formed with a stepped stop portion located beside the mounting portion to stop the respective bearing seat.

13. The hub in accordance with claim 1, wherein each of the bearing seats has a substantially annular shape.

14. The hub in accordance with claim 3, wherein each of the positioning grooves of each of the bearing seats is substantially arc-shaped.

15. The hub in accordance with claim 3, wherein each of the positioning grooves of each of the bearing seats extends in an axial direction of each of the bearing seats.

16. The hub in accordance with claim 3, wherein the positioning ribs of the mounting portion of the hub body are slidably inserted into the positioning grooves of each of the bearing seats respectively when each of the bearing seats is fitted into the mounting portion of the hub body.

17. The hub in accordance with claim 1, wherein each of the bearings is encompassed by and fully hidden in the respective bearing seat.

18. The hub in accordance with claim 2, wherein when each of the two opposite sides of the hub body is subjected to an outwardly pulled radial stress applied by the spokes, each of the bearing seats is located between the hub body and the respective bearing to eliminate the radial stress applied on each of the two opposite sides of the hub body by the spokes, so tat each of the bearings is mounted in the hub body closely and will not be loosened from the hub body easily.
